(19) United States
(12) Patent Application Publication
(10) Pub. No.: US 2019/0012303 A1
(43) Pub. Date: Jan. 10, 2019

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventors: Takuya OKAMOTO, Kanagawa (JP); Takenori MATSUO, Kanagawa (JP); Rumiko KAKEHI, Kanagawa (JP); Atsushi MARUYAMA, Kanagawa (JP); Naoki OKAMOTO, Kanagawa (JP)

(73) Assignee: FUJI XEROX CO., LTD., Tokyo (JP)

(21) Appl. No.: 16/018,479

(22) Filed: Jun. 26, 2018

(30) Foreign Application Priority Data
Jul. 10, 2017 (JP) 2017-134846

(51) Int. Cl. G06F 17/24; G06T 11/00; G06F 17/30; G06F 3/0483

(52) U.S. Cl. CPC G06F 17/241; G06T 11/001; G06F 3/0483; G06F 17/30353; G06F 17/30368

(57) ABSTRACT

An information processing apparatus includes: an attachment information assignor that assigns a comment on an electronic document made by a user as attachment information associated with a corresponding portion in the electronic document; and a conclusion attribute assignor that assigns a conclusion attribute in association with the attachment information, the conclusion attribute being an attribute indicating a type of conclusion of the attachment information.

### CROSS-REFERENCE TO RELATED APPLICATIONS

This application is based on and claims priority under 35 USC 119 from Japanese Patent Application No. 2017-134846 filed on Jul. 10, 2017.

### BACKGROUND

### Technical Field

The present invention relates to an information processing apparatus, an information processing system, and a non-transitory computer readable medium.

### SUMMARY

According to an aspect of the invention, there is provided a an information processing apparatus including: an attachment information assignor that assigns a comment made by a user to an electronic document as attachment information associated with a corresponding portion in the electronic document; and a conclusion attribute assignor that assigns a conclusion attribute in association with the attachment information, the conclusion attribute being an attribute indicating a type of conclusion of the attachment information.

### BRIEF DESCRIPTION OF THE DRAWINGS

Exemplary embodiment of the present invention will be described in detail based on the following figures, wherein:

FIG. 1 illustrates an entire configuration example of an information processing system to which an exemplary embodiment is applied;

FIGS. 2A and 2B each illustrates a state where a virtual sticky is inserted in an electronic document;

FIG. 3 is a block diagram illustrating a functional configuration example of a terminal apparatus and a document management server;

FIG. 4 illustrates an example of a dialog which is displayed when a user assigns a conclusion attribute;

FIG. 5A is a table illustrating attributes assigned by a conclusion attribute assignor, and FIG. 5B illustrates a relationship between sticky IDs and area ID;

FIG. 6 illustrates a result of organization of stickies performed by a display controller;

FIG. 7A illustrates an example in which a page on which a sticky having a conclusion attribute of “finished” is placed and the subsequent few pages are extracted from the electronic document A (A document) of FIG. 6, and FIG. 7B illustrates an example in which a page on which a sticky having a conclusion attribute of “turn down” is placed and the subsequent few pages are extracted from the electronic document B (B document) of FIG. 6;

FIG. 8 illustrates a notification made to a user who is to assign a conclusion attribute; and

FIG. 9 is a flowchart illustrating the operation of a terminal apparatus.

### DETAILED DESCRIPTION

### <Description of Entire Configuration of Information Processing System>

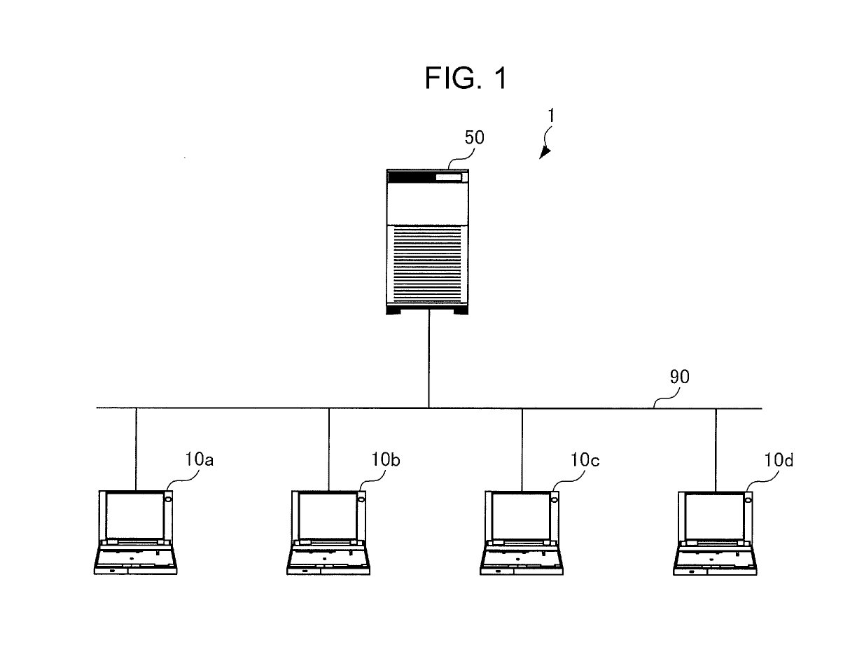

Hereinafter, an exemplary embodiment of the invention will be described in detail with reference to the accompanying drawings. FIG. 1 illustrates an entire configuration example of an information processing system to which the exemplary embodiment is applied. In an information processing system 1 illustrated, terminal apparatuses 10a, 10b, 10c, and 10d are connected to a network 90. In addition, a document management server 50 is connected to the network 90.

Although the terminal apparatuses 10a, 10b, 10c, and 10d are illustrated in FIG. 1, when these terminal apparatuses do not need to be distinguished, the terminal apparatuses are referred to as the terminal apparatus 10. Although four terminal apparatuses 10 are illustrated in FIG. 1, the number of terminal apparatuses 10 may be any integer.

The terminal apparatus 10 is an example of an information processing apparatus. In the exemplary embodiment, a user utilizes the terminal apparatus 10 to view an electronic document stored in the document management server 50. At this point, a user can make a comment on the electronic document. Thus, comments on the electronic document can be exchanged between users. The “electronic document” herein refers to content created utilizing an electronic medium, and includes application content created by application software, and scanner content digitized by a scanner. The application content includes document information, image information, and video information. The scanner content includes a digitized document in which a paper document is digitized by a scanner. A computer apparatus, such as a personal computer (PC), a mobile terminal, and a mobile phone can be used as the terminal apparatus 10.

The terminal apparatus 10 includes a central processing unit (CPU) which is a calculation unit, and a main memory and a hard disk drive (HDD) which are each a memory. Here, the CPU executes various types of software, such as an operating system (OS), basic software, and an application program (application software). Also, the main memory is a memory area that stores various types of software and data used for execution of the various types of software, and the HDD is a memory area that stores input data to various types of software, and output data from various types of software. Furthermore, the terminal apparatus 10 includes a communication interface (hereinafter abbreviated as a “communication I/F”) for communication with the outside, a display mechanism including a video memory and a display, and an input device such as a keyboard and a mouse.

The document management server 50 is an example of an electronic document management apparatus. The document management server 50 manages electronic documents viewed by users.

A network 90 is a communication unit used for communication of information between terminal apparatuses 10, or between the terminal apparatus 10 and the document management server 50, and for instance, is a local area network (LAN). The network 90 is not limited to this, and may be the Internet.

Next, the operation of the information processing system 1 will be described. Here, a description is given below under the assumption that specifications to be used for application software development are created as an electronic document. For instance, a case is assumed where a user requests a review of the electronic document from other relevant users. In this case, a user who has received the review request checks the content of the electronic document and writes a comment on the electronic document. A user who has received the review request can also write a reply comment on the written comment. Work of correcting the content is performed until an agreement is reached between the relevant users who communicate with each other, and a series of work is stored as a business record.

At this point, the electronic document is stored in the document management server 50. The electronic document is stored, for instance, in a shared folder, and each user can view the electronic document from the terminal apparatus 10. When a comment is written in the electronic document, a virtual sticky is inserted in the electronic document as attachment information. Here, the “attachment information” is information which is assigned associated with a description in the electronic document. The attachment information may be added to an electronic document as an annotation or added to an electronic document as an attachment file. Although the detail will be described later, when attachment information is added to an electronic document as an annotation, the attachment information is internally embedded in a corresponding portion of the electronic document as annotation information. In the case of attachment file, the attachment file is added as a separate file in association with files of the electronic document. In the exemplary embodiment, attachment information is added to an electronic document as an annotation. The content of attachment information is, for instance, a comment, an instruction, and an index on a description in the electronic document. The attachment information is presented to a user by display with a mark such as a stamp, display with another window, or display with a different layer from the electronic document, in addition to display with a virtual sticky.

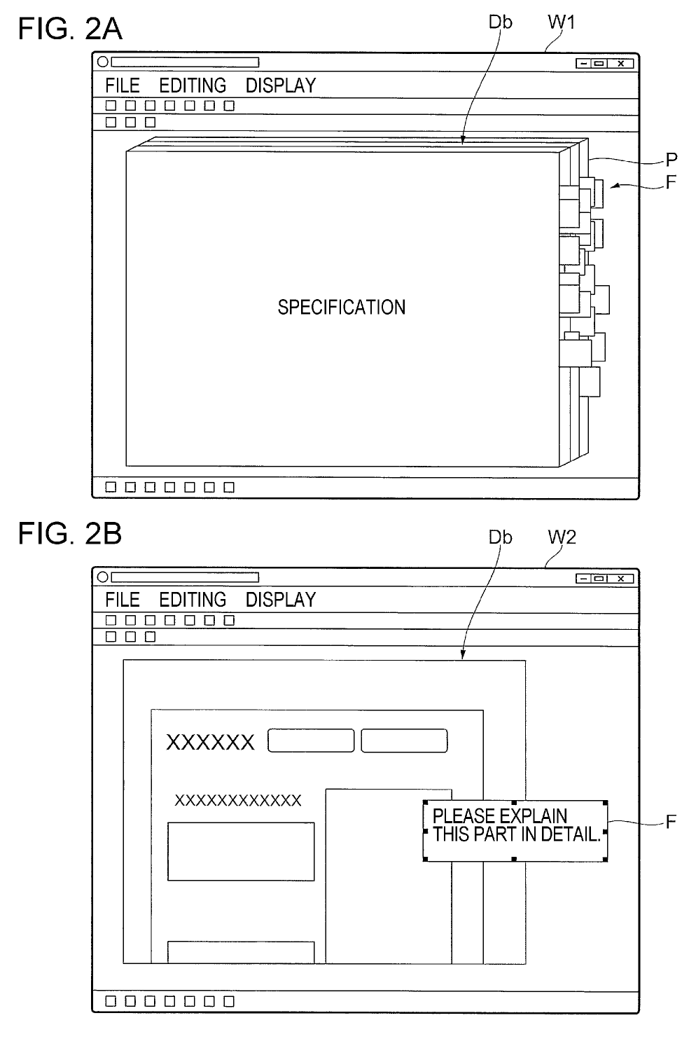

FIGS. 2A and 2B each illustrate a state where a virtual sticky is inserted in an electronic document. FIG. 2A illustrates a state where specifications which is an electronic document are not opened. FIG. 2A illustrates window W1 displayed on a display mechanism of the terminal apparatus 10. In the window W1, the cover of “specifications” is displayed as an electronic document Db. Furthermore, the electronic document Db includes of multiple pages P, and other pages P under the cover are schematically displayed. Also, it is seen that sticky F inserted in the specifications is displayed protruding from the document space, and a comment is written on the sticky F. The color and position of the sticky F can be changed by a user. The electronic document Db can be opened similarly to actual books, and when the electronic document Db is opened, an opened page P is displayed. That is, a user can turn over page P one at a time, and can view the content of the electronic document Db. When the number of page P is inputted in a page number input field (not illustrated), control is jumped to the page P, and the page can be viewed. In this case, in any opened page P, the presence of the sticky F can be recognized at a glance. Furthermore, when the sticky F is selected by an operation such as clicking, control is jumped to the page P on which the sticky F is placed and the page P can be viewed.

FIG. 2B illustrates a state where the page P on which the sticky F is placed is opened. FIG. 2B illustrates window W2 displayed on the display mechanism of the terminal apparatus 10. As illustrated, a state where the electronic document Db is opened is displayed in the window W2. The content written on the opened page P is displayed, and the sticky F placed on the page P is displayed. A comment written by a user is displayed on the sticky F. It is to be noted that another window may be opened and a comment may be displayed in the window. Here, an example is illustrated, in which a comment stating that “please explain this part in detail” is written for a description of the page P.

Also, another user who has read the comment can make a reply comment to the comment. When another user makes a reply comment, another sticky F is placed near a previously placed sticky F, and a reply comment is written in another sticky F.

The comments written in an electronic document have various characteristics. The characteristics include, for instance, request, question, approval, objection, and proposal. The content may be a comment in which important information is written or an insignificant comment which does not affect to other comments. Like this, the characteristics and the content vary with comments, and thus various conclusions may be drawn for one document depending on the exchanged comments on the electronic document. The conclusion may indicate, for instance, “finished”, “on hold”, or “turn down”. Even when the conclusion indicates “finished”, the exchange may be finished based of the agreement between the users, or the exchange may be finished under some conditions. In other words, many conclusions may be possible even for one electronic document.

However, in such a situation, it is difficult for coworkers who work based on the electronic document or check with the electronic document later to identify the conclusion. Specifically, it is necessary to review the comments exchanged one by one, and it takes tremendous amount of time and effort to identify the conclusion of the exchange. In addition, comments having various characteristics are left in electronic document without being distinguished, and thus it may be difficult to grasp necessary comments exchanged. Furthermore, all the comments exchanged are not necessarily summarized in one electronic document, and may be distributed over multiple electronic documents. Thus, in the exemplary embodiment, as described later, this problem is addressed by assigning an attribute indicating a type of conclusion to a comment or organizing stickies by a user who makes the comment.

### <Description of Terminal Apparatus 10 and Document Management Server 50>

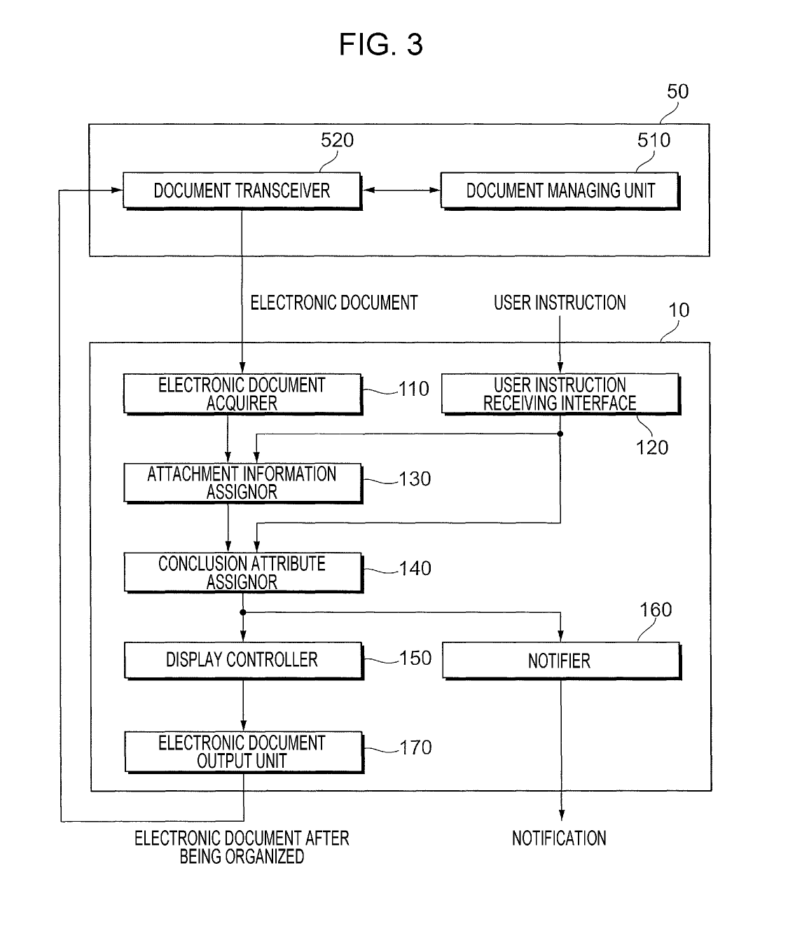

Next, the terminal apparatus 10 of the exemplary embodiment will be described in full detail. FIG. 3 is a block diagram illustrating a functional configuration example of the terminal apparatus 10 and the document management server 50. It is to be noted that the functions of the exemplary embodiment among various functions of the terminal apparatus 10 and the document management server 50 are selected and illustrated.

The document management server 50 illustrated includes a document management unit 510 that manages electronic documents, and document transceiver 520 that transmits and receives electronic documents. The document management unit 510 manages electronic documents as well as stores electronic documents. The document transceiver 520 transmits an electronic document to the terminal apparatus 10. When attachment information such as a sticky is assigned, the document management server 50 receives an electronic document after attachment information is assigned, and stores the electronic document in the document management unit 510.

The terminal apparatus 10 illustrated includes an electronic document acquirer 110 that acquires an electronic document, a user instruction receiving interface 120 that receives a user instruction, an attachment information assignor 130 that attaches attachment information to an electronic document, a conclusion attribute assignor 140 that assigns a conclusion attribute to attachment information, a display controller 150 that controls the content to be displayed on a display mechanism, a notifier 160 that notifies to a user, and an electronic document output unit 170 that outputs an electronic document.

The electronic document acquirer 110 acquires an electronic document from the document transceiver 520 of the document management server 50 via the network 90.

Practically, when the icon or the like of an electronic document stored in a shared folder displayed on the display mechanism of the terminal apparatus 10 is selected by operating an input device such as a mouse, document data of the electronic document is downloaded from the document management server 50. The electronic document is then opened by predetermined application software, and is displayed on the display mechanism.

The user instruction receiving interface 120 receives a comment on the electronic document made by a user, as a user instruction. The user instruction receiving interface 120 also receives input of an attribute such as a conclusion attribute, as a user instruction.

The attachment information assignor 130 assigns the comment made by a user to the electronic document as attachment information associated with a corresponding portion in the electronic document. In the case where a user who has viewed an electronic document writes a comment, for instance, when “sticky” is selected from the tool bar of application software which displays the electronic document, a virtual sticky is placed on the page currently viewed. The sticky can be moved to a position which is regarded to be appropriate by a user. The user then operates the input device and writes a comment in the sticky. As a result, the sticky F with the comment written is displayed as in FIG. 2B. Comments on an electronic document are exchanged between users by repeating this process.

The conclusion attribute assignor 140 assigns a conclusion attribute corresponding to attachment information, the conclusion attribute being an attribute indicating a type of a conclusion of the attachment information. Here, the “conclusion attribute” is information that indicates a conclusion of the comments between users. The conclusion attribute may be a conclusion attribute meaning that exchange of comments between users is finished, or may be a conclusion attribute meaning that exchange of comments between users is unfinished. When the exchange of comments is finished, a conclusion attribute of “finished”, which means that subsequent exchange of comments is unnecessary, is assigned. When the exchange of comments is unfinished, a conclusion attribute of “on hold”, which means that it has not been determined whether or not subsequent exchange of comments is unnecessary, is assigned, or a conclusion attribute of “turn down”, which means that subsequent exchange of comments is necessary, is assigned.

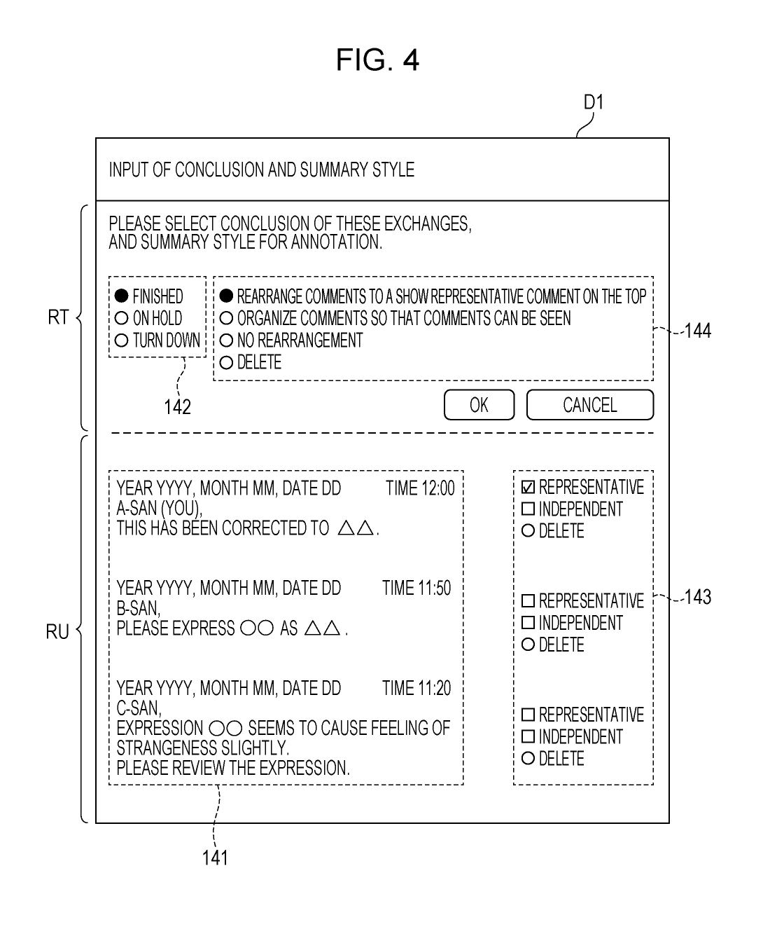

FIG. 4 illustrates an example of a dialog which is displayed when a user assigns a conclusion attribute. A dialog D1 illustrated is displayed on the display mechanism. In the dialog D1, a field 141, which displays exchange of comments between users up to now, is provided in a lower area RU, and the comments written by the users are displayed. In this case, user C (displayed as “C-san” in FIG. 4) first, writes a comment stating “The expression OO seems to cause feeling of strangeness slightly. Please review the expression”, and user B (displayed as “B-san” in FIG. 4) writes a comment stating “Please express OO as ΔΔ” as a reply comment. Then user A (displayed as “A-san” in FIG. 4) writes a comment stating “This has been corrected to ΔΔ” as a reply comment. The dates and times at which these comments are written are displayed together. The example illustrates the case where user A assigns a conclusion attribute for the comment made by the user A.

In the dialog D1, a field 142 for inputting a conclusion attribute is provided in an upper area RT. Here, user A determines that subsequent exchange of comments will not continue, and in the field 142, selects a radio button of “finished” which assigns a conclusion attribute of “finished”. Here, optionally, when it is unclear whether or not subsequent exchange of comments is necessary, a radio button of “on hold” may be selected. In addition, here, when further continuation of subsequent exchange of comments is necessary, a radio button of “turn down” may be selected. Here, the example illustrates the case where user A selects “finished” for the comment made by the user A.

Also, user A can input “evaluation for comment” in a field 143. Here, “evaluation for comment” indicates what type of significance each comment has in a series of comments. The evaluation for a comment may be determined based on the degree of importance of the content of each comment in a series of comments, or based on the relation with other comments. Here, for each comment, one of “representative”, “independent”, and “delete” may be selected. The “representative” is evaluation determined based on the degree of importance of a comment, and is selected as a representative comment among the comments. In this case, for instance, an important comment, which is the most associated with a conclusion attribute, is selected as the representative comment. Also, the “independent” is evaluation determined based on the relation with other comments, and is selected when a comment is desired to be managed separately from other comments. A comment for which “independent” is selected corresponds to, for instance, an item of “to do” or important reference information included in the exchange of comments. In addition, “delete” is evaluation determined based on the degree of importance of a comment, and is selected when the degree of importance is low and it is not necessary to leave the comment. Here, the example illustrates the case where user A selects “representative” for the comment made by the user A.

Furthermore, in a field 144, user A can specify a summary style for the series of comments. Here, one of “rearrange comments to show a representative comment on the top”, “organize comments so that comments can be seen”, “no rearrangement”, and “delete” can be selected. Among these, “rearrange comments to show a representative comment on the top” allows the stickies, in which the comments of user B and user C are written, to be bundled and displayed, and the sticky, in which the comment of user A is written, to be displayed on the top of those comments. This option is selected when the comment of user A is important and the degree of importance of other comments is not high. In this case, a sticky assigned a representative attribute is placed on the top, and other stickies are bundled under the sticky. Also, the “organize comments so that comments can be seen” allows all the stickies, in which the comments of user A, user B, and user C are written, to be displayed so as to be seen. This option is selected when the comments of user A, user B, and user C are all important. In this case, the stickies are organized so that each sticky can be seen without overlapping of display of the stickies. For instance, the stickies are arranged not to overlap. Also, the “no rearrangement” does not change a portion on which each sticky is placed. This option is selected when the position at which each sticky is placed is important, and change of the position of each sticky is not desired to be made. The “delete” deletes the sticky in which the comment of user A is written, and such sticky remains. This option is selected when the degree of importance of a comment made by user A is low, and it is not necessary to leave the comment. Here, a case is illustrated where user A selects “rearrange comments to show a representative comment on the top”.

The timing of assigning a conclusion attribute is not particularly limited. For instance, when exchange of comments is temporarily settled, a conclusion attribute may be assigned. For instance, when a user writes a comment, the dialog D1 may be displayed, and each time a comment is written, a conclusion attribute may be assigned. For instance, at the timing of assigning a specific annotation (for instance, a stamp of “settled” is placed) on a comment or at the timing of writing a specific keyword (for instance, “complete”, “finished”), the above-mentioned dialog D1 may be displayed, and a conclusion attribute may be assigned.

Although a user who can assign a conclusion attribute may be a user who has participated in the exchange of comments. However, without being limited to this, for instance, a person who is specially authorized, such as an administrator of the document management server 50, may assign a conclusion attribute. Alternatively, restriction may be imposed on a person who is specially authorized, and such a person may be selected in advance. For instance, definition information on users who are authorized to assign a comment may be stored in the document management server 50, and whether or not a user is authorized to assign a comment can be determined by referring to the definition information.

Each time a conclusion attribute is assigned, a history of assignment may be stored. In this case, even when a conclusion attribute which is not intended is assigned, the flow of comments can be referred to based on the history.

Also, in the exemplary embodiment, the conclusion attribute assignor 140 may set not only a conclusion attribute, but also other related attributes.

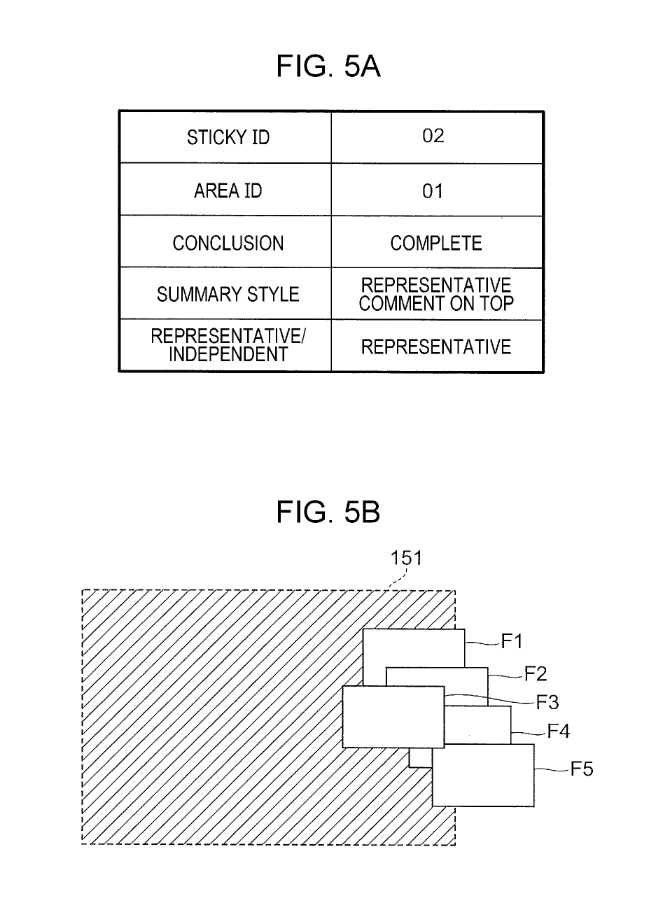

FIG. 5A is a table illustrating the attributes assigned by the conclusion attribute assignor 140. The attributes illustrated indicate sticky ID, area ID, conclusion, summary style, and representative/independent. Here, the “sticky ID” indicates identification information assigned to each sticky. Also, the “area ID” is identification information assigned to an area of an electronic document, on which a series of stickies are placed.

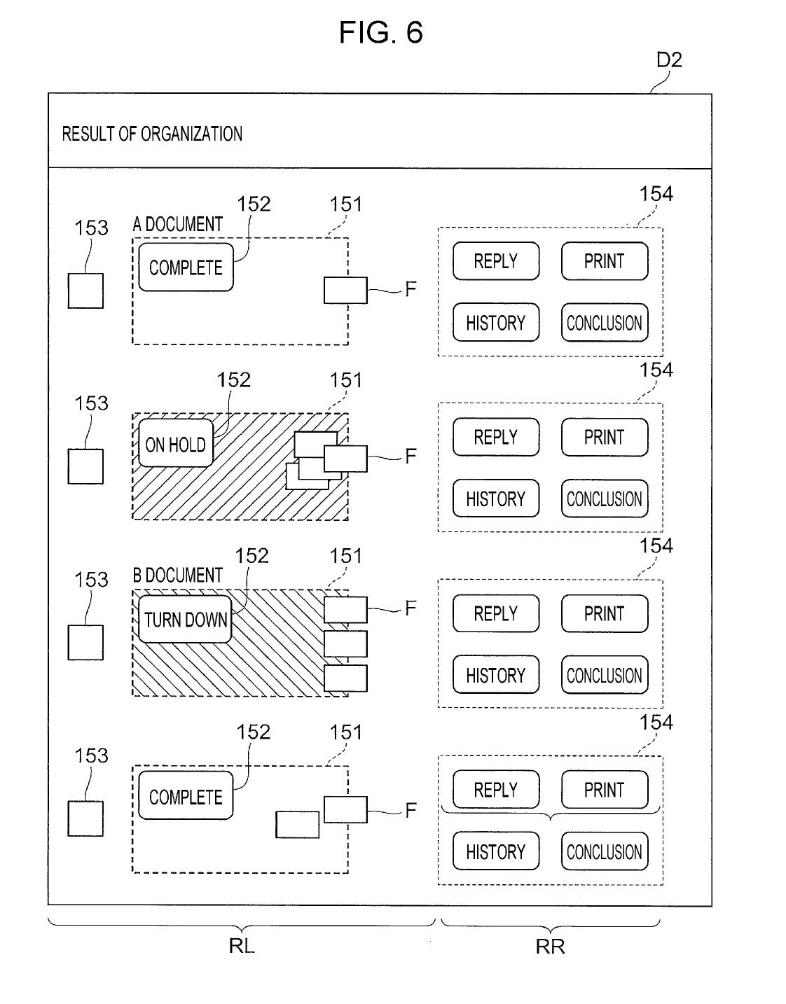

FIG. 5B illustrates a relationship between sticky IDs and area ID. Although details will be described later in FIG. 6, the display controller 150 performs control to extract the sticky F as well as the positions of an electronic document, on which the sticky F is placed, and to display both the sticky F and the positions. Here, an extracted area 151 and stickies F placed on the positions are illustrated. The area ID is an ID assigned to the area 151, and for instance, an area ID=1 is assigned. Also the sticky ID is an ID assigned to each sticky placed here, and for instance, the sticky IDs=01 to 05 are assigned to the illustrated stickies F1 to F5, respectively.

Thus, it can be identified that on which area in the electronic document, each sticky F is placed. Thus, multiple stickies F can be associated with each other and comments can be associated with each other based on the area ID. Specifically, stickies F assigned the same area ID include comments written for the same portion in the electronic document, and can be regarded as one formed group.

Furthermore, the “conclusion” is the above-described conclusion attribute, and one of “finished”, “on hold”, and “turn down” is set to the “conclusion”. Furthermore, the “summary style” indicates one of styles of summary: “rearrange comments to show a representative comment on the top”, “organize comments so that comments can be seen”, and “no rearrangement” described above. An attribute of one of “representative comment on the top”, “rearrangement”, and “no rearrangement” is set to the “summary style”. Furthermore, the “representative/independent” is an attribute which is set when the “representative” or “independent” is selected. These attributes can be internally embedded for each of areas in the electronic document as an annotation.

Returning to FIG. 3, the display controller 150 performs control to display multiple pieces of attachment information based on a certain rule. In this process, when multiple pieces of attachment information are displayed, the display controller 150 performs control to organize and display the multiple pieces of attachment information by a predetermined method. In the exemplary embodiment, “organization” refers to organizing attachment information based on the attributes assigned by the conclusion attribute assignor 140. In this process, the display controller 150 performs control to organize the attachment information as well as the arrangement of display of the stickies base on the attributes. Thus, the display controller 150 can distinguish the characteristics of the comments written in the electronic document, and can organize the stickies by reflecting the characteristics.

FIG. 6 illustrates a result of organization of stickies performed by the display controller 150. Here, a case is illustrated where the result of organization of stickies performed by the display controller 150 is displayed as a dialog D2 on the display mechanism. In this case, the display controller 150 performs control to collectively display multiple pieces of attachment information for each of the conclusion attributes.

Specifically, the display controller 150 performs control to collectively display attachment information assigned a conclusion attribute and a comment which leads to the conclusion attribute in left-side area RL of the dialog D2. Specifically, in the electronic document A (A document), for sticky F having a conclusion attribute of “finished”, the sticky F and related stickies F having the same area ID are collectively displayed on the first row of the left-side area RL. For instance, in the example described with reference to FIG. 4, the sticky F placed by user A has a conclusion attribute of “finished”, thus the example corresponds to this case. The stickies F placed by user B and user C related to the sticky F placed by user A are also collected and displayed as related stickies F.

Furthermore, here, in the electronic document A (A document), for sticky F having a conclusion attribute of “on hold”, the sticky F and related stickies F having the same area ID are collectively displayed on the second row of the left-side area RL.

Similarly, in an electronic document B (B document), for sticky F having a conclusion attribute of “turn down”, the sticky F and related stickies F having the same area ID are collectively displayed on the third row of the left-side area RL.

Furthermore, here, in the electronic document B (B document), for sticky F having a conclusion attribute of “finished”, the sticky F and related stickies F having the same area ID are collectively displayed on the fourth row of the left-side area RL.

Furthermore, when multiple stickies F assigned the same conclusion attribute are present, the multiple stickies F can be collectively displayed even with a different area ID of the stickies F. Consequently, for instance, the comments associated with the sticky F having a specific conclusion attribute can be collectively viewed.

Also, in the exemplary embodiment, the display controller 150 performs control to display corresponding portions assigned attachment information in the electronic document in association with each other. Here, the display controller 150 extracts the portions of the electronic document, on which the sticky F is placed, and displays the portions along with the sticky F. In this case, part of a page, on which the sticky F is placed, is extracted and displayed. It is to be noted that in FIG. 6, an extracted portion is indicated by the area 151 with a dotted line. This is part of the electronic document on which a comment is to be made.

Furthermore, in the exemplary embodiment, the display controller 150 performs control to display attachment information by changing the color and the stamp which indicate a conclusion attribute according to the conclusion attribute. For instance, when the conclusion attribute is “finished”, “on hold”, and “turn down”, the display controller 150 display white color, yellow color, and blue color, respectively. Also, FIG. 6 illustrates an example in which stamp 152 of “finished”, “on hold”, and “turn down” is actually put. Furthermore, at this point, a user name who has assigned a conclusion attribute, and the time at which a conclusion attribute was assigned may be displayed. In this manner, the conclusion is displayed in a comprehensible way, and even a coworker who views the electronic document later can easily grasp the organized result.

Also, stickies F are displayed in accordance with a summary style. For instance, when a sticky F having an attribute of “representative comment on the top” is present as a summary style, the display controller 150 performs control to display attachment information strongly associated with a conclusion attribute together. In this case, for instance, as described above, the display controller 150 places the sticky F assigned a representative attribute on the top (front surface), and bundles other stickies F under the sticky F.

In the example of FIG. 6, the case of “finished” on the first row of the electronic document A (A document) corresponds to this. Specifically, as illustrated in FIG. 4, since the comment of user A is assigned an attribute of “representative” and an attribute of “representative comment on the top”, the sticky F on which the comment of user A is written is placed on the top, and the stickies F of other users are collectively displayed and bundled under the sticky F.

For instance, when a sticky F having an attribute of “rearrangement” is present as a summary style, as described above, the display controller 150 performs control to collectively display the attachment information so that representations of the attachment information do not overlap. For instance, the stickies F are collectively arranged so as not to overlap. In the example of FIG. 6, the case of “turn down” on the third row of the electronic document B (B document) corresponds to this. In other words, this is an example in which an attribute of “rearrangement” is assigned to the comment of a user illustrated in FIG. 4. Therefore, all the stickies F, each on which a comment of a user is written, are displayed to be seen.

Furthermore, the case of “on hold” on the second row of the electronic document A (A document) provides an example in which an attribute of “no rearrangement” is assigned to the comment of a user. Therefore, the stickies F, each on which a comment of a user is written, are displayed without changing the positions on which the stickies F are placed. The same goes with the case of “finished” on the fourth row of the electronic document B (B document).

Also, when a sticky F having an attribute of “independent” is present as a summary style, the color or the font may be changed to identify the attribute.

In FIG. 6, a check box 153 is further provided for each result of organization of the stickies F, and the check box 153 can be selected by clicking or the like. Furthermore, here, the buttons “reply”, “print”, “history”, and “conclusion” are provided in right-side area RR. After one check box 153 is selected, one of the buttons in an area 154 can be selected by clicking or the like. In this case, when a comment is desired to be further added, the “reply” is selected from the screen. Also, when a series of comments are desired to be printed, the “print” is selected. Also, when a series of comments are desired to be viewed, the “history” is selected. Also, when the conclusion attributes assigned a series of comments are desired to be referred to, the “conclusion” is selected.

Here, although the display controller 150 organizes the stickies for each electronic document, the display controller 150 may organize the stickies similarly for multiple documents. In this case, for multiple electronic documents, the display controller 150 performs control to organize and collectively display the attachment information based on a conclusion attribute. Specifically, for instance, the electronic document A (A document) and the electronic document B (B document) are handled as one electronic document, and the stickies F are organized and arranged based on a conclusion attribute.

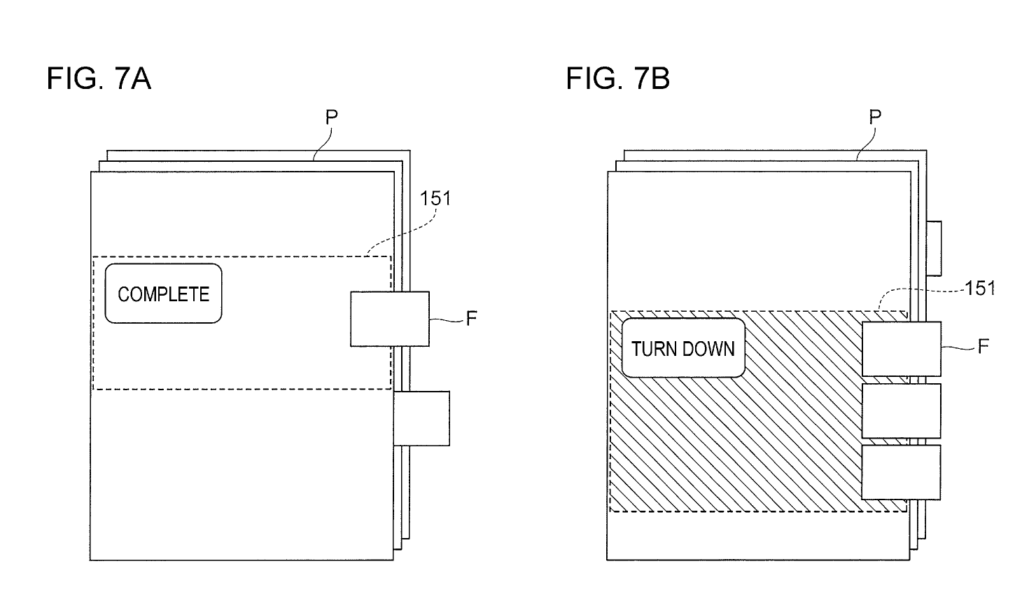

Also, when corresponding portions, on which the sticky F is placed, in the electronic document are extracted, the display controller 150 may extract not only the portion, but also the entire page on which the sticky F is placed, or preceding or subsequent few pages, or the page and subsequent few pages. FIG. 7A illustrates an example in which a page on which the sticky F having a conclusion attribute of “finished” is placed and the subsequent few pages along with the above-mentioned area 151 are extracted from the electronic document A (A document) of FIG. 6. Here, the extracted page is illustrated as the page P. Also, FIG. 7B illustrates an example in which a page on which the sticky F having a conclusion attribute of “turn down” is placed and the subsequent few pages along with the above-mentioned area 151 are extracted from the electronic document B (B document) of FIG. 6. Here, the extracted page is also illustrated as the page P.

Returning to FIG. 3 again, the notifier 160 notifies a predetermined user. For instance, when a conclusion attribute is assigned, the notifier 160 notifies a user who has made a comment on a sticky assigned the conclusion attribute. In other words, the notifier 160 notifies the users who have participated in the series of exchanges of comments that a conclusion attribute has been assigned. Without being limited to this, the notifier 160 may notify predetermined users even if the users have not participated in the exchanges of comments. The users to be notified may be set, for instance, as definition information in the document management server. Also, notification may be made each time a conclusion attribute is assigned, or may be collectively made for one electronic document. It is to be noted that the notification may be made, for instance, by using a method such as an E-mail.

Also, when a conclusion attribute is not assigned in a predetermined period, the notifier 160 may notify a user who is to assign a conclusion attribute.

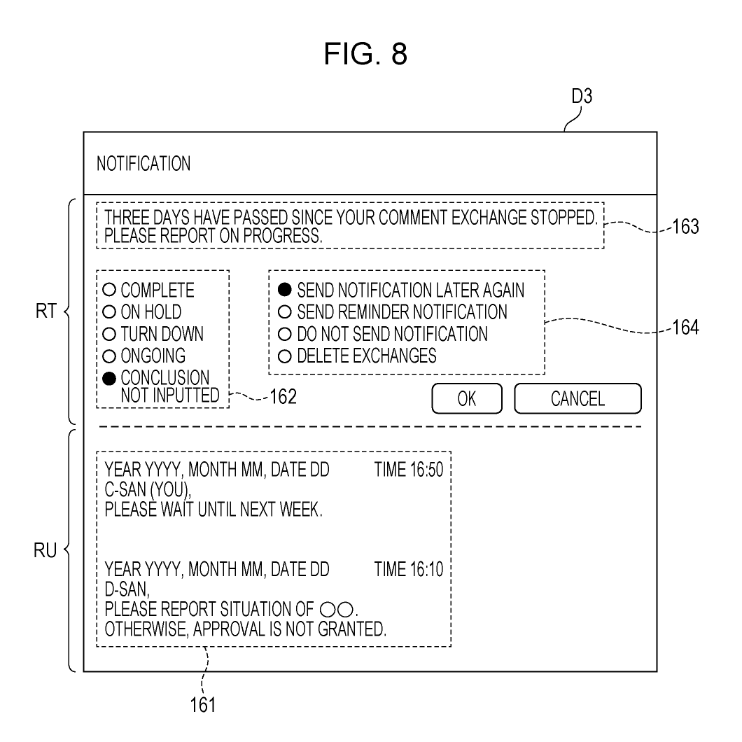

FIG. 8 illustrates a notification made to a user who is to assign a conclusion attribute. A dialog D3 illustrated is displayed on the display mechanism. Similarly to FIG. 4, in the dialog D3, a field 161 for displaying exchange of comments by users up to now is provided in a lower area RU. Also, a field 162 for inputting a conclusion attribute is provided in an upper area RT. Also, a field 163 of notification is provided in the upper area RT, and an example is illustrated in which notification of “Three days have passed since your comment exchange stopped. Please report on progress” is made. Specifically, this illustrates a case where user C who is to assign a conclusion attribute has not assigned a conclusion attribute in the last three days, which is a predetermined period, and thus user C is notified. It is to be noted that the predetermined period may be set in a uniform manner, or may be set for each electronic document.

Similarly to FIG. 4, the field 162 for inputting a conclusion attribute is provided in the upper area RT. However, here, “ongoing” and “conclusion not inputted” may be selected as a conclusion attribute in addition to the “finished”, “on hold”, and “turn down”. Here, “ongoing” is selected when the exchange of comments is ongoing. Also, the “conclusion not inputted” is selected when input of a conclusion attribute is on hold. Furthermore, here, a field 164 for inputting a response to the above-mentioned notification is provided. Specifically, one of “send notification later again”, “send reminder notification”, “do not send notification”, and “delete exchanges” can be selected.

The notification may be made at the timing when a user (user C in this case) opens the electronic document after the predetermined period, or may be made by using a method such as an E-mail. The notification may be made to not only a user who is to assign a conclusion attribute but also to the users who have participated in the exchange of comments. Furthermore, the notification may be made to predetermined users even if the users have not participated in the exchange of comments.

Returning to FIG. 3 again, the electronic document output unit 170 outputs the attribute assigned by the conclusion attribute assignor 140 and the electronic document organized by the display controller 150 to the document management server 50. The electronic document is sent to the document management server 50, and is stored in the document management unit 510 via the document transceiver 520.

### <Description of Operation of Terminal Apparatus 10>

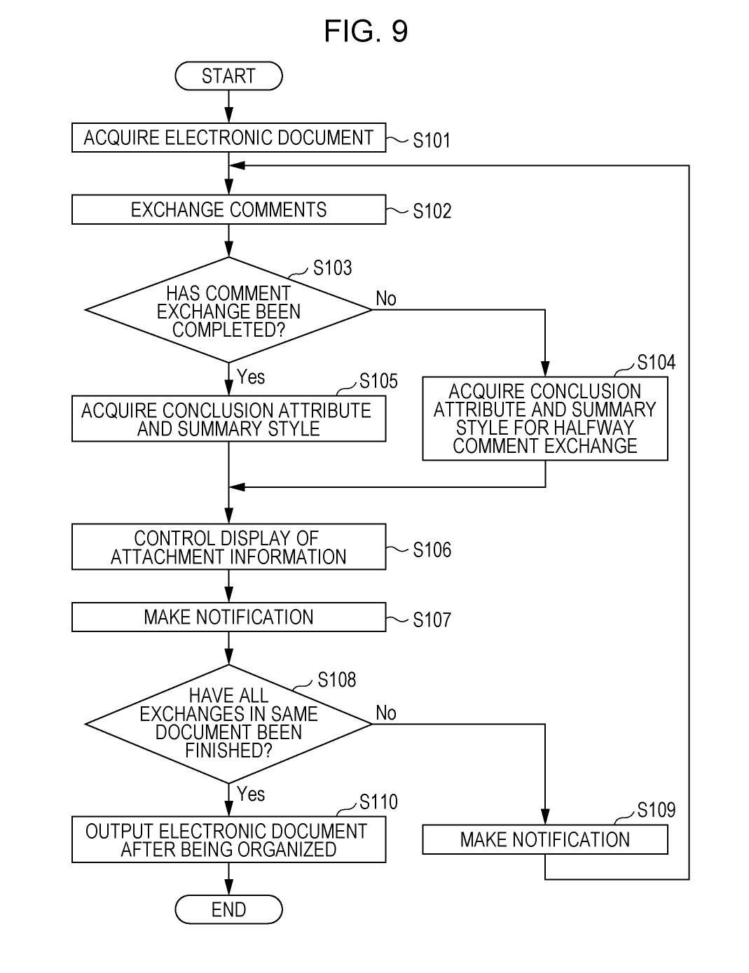

FIG. 9 is a flowchart illustrating the operation of the terminal apparatus 10. First, the electronic document acquirer 110 acquires an electronic document from the document management server 50 (step 101). When a user who has viewed the electronic document desires to make a comment on the electronic document, as described above, the user applies a sticky and writes a comment on the electronic document. In this case, the attachment information assignor 130 places the comment as a sticky associated with a corresponding portion in the electronic document, and thus exchanges the comment (step 102).

Next, the conclusion attribute assignor 140 determines whether or not exchange of comments between users has been finished (step 103). Whether or not exchange of comments has been finished may be explicitly determined by assigning a conclusion attribute of “finished” by a user, or determined based on whether or not a predetermined time has elapsed.

As a result, when the exchange has not been finished (No in step 103), the conclusion attribute assignor 140 displays, for instance, the dialog D1 illustrated in FIG. 4 on the display mechanism. For halfway exchange of comments, a conclusion attribute or an attribute such as a summary style is acquired (step 104). When halfway exchange of comments has been finished (Yes in step 103), the conclusion attribute assignor 140 displays, for instance, the dialog D1 illustrated in FIG. 4 on the display mechanism. When a user inputs a final conclusion attribute or an attribute such as a summary style, the conclusion attribute assignor 140 acquires the attribute (step 105). The attribute is stored in association with the sticky in the form as illustrated in FIGS. 5A and 5B, for instance.

The display controller 150 performs control to display multiple pieces of attachment information based on a certain rule (step 106). Here, the display controller 150 performs control to collectively display multiple stickies for each conclusion attribute, for instance, as illustrated in FIG. 6. The notifier 160 then notifies users who has made a comment up to now on the sticky assigned the conclusion attribute (step 107).

Next, the notifier 160 determines whether or not all the exchanges of comments in the electronic document have been finished (step 108). As a result, when some exchanges have not been finished (No in step 108), the notifier 160 makes notification as illustrated in FIG. 8 to a user (step 109). Subsequently, the flow returns to step 102. When all the exchanges of comments have been finished (Yes in step 108), the electronic document output unit 170 outputs the attribute assigned by the conclusion attribute assignor 140 and the electronic document organized by the display controller 150 to the document management server 50 (step 110).

The terminal apparatus 10 described above causes a user to input a conclusion attribute. Therefore, when comments are exchanged between users, it is made easier to identify the conclusion of the exchange by writing a comment to the electronic document.

With the terminal apparatus 10 described above, the display controller 150 organizes stickies and performs control to display the stickies. In short, the display controller 150 can collectively display the stickies. Thus, distribution of comments to different locations or other electronic documents can be reduced. As a consequence, a user can easily grasp a series of exchanges, and overlooking of important information can be reduced. When a user, who joins the exchange in the middle or later, views the exchange, can obtain the same information as the users who have participated in the exchange from the beginning.

With the terminal apparatus 10 described above, the notifier 160 makes notification for prompting input of a conclusion attribute for an exchange not assigned a conclusion attribute. Consequently, an unassigned conclusion attribute can be reduced.

In the information processing system 1 described in detail above, the processing performed by the attachment information assignor 130, the conclusion attribute assignor 140, the display controller 150, and the notifier 160 is carried out by the terminal apparatus 10. However, all or part of the processing may be performed by the document management server 50.

### <Description of Program>

The processing performed by the terminal apparatus 10 is implemented by the CPU of the terminal apparatus 10 executing various types of software. Thus, the processing performed by the document management server 50 can be regarded as a program that achieves a function of assigning a comment on an electronic document made by a user as attachment information associated with a corresponding portion in the electronic document; and a function of assigning a conclusion attribute in association with the attachment information, the conclusion attribute being an attribute indicating a type of conclusion of the attachment information.

Needless to say, a program that implements the exemplary embodiment can be provided by a communication unit, as well as by a recording medium, such as a CD-ROM, which stores the program.

Although the exemplary embodiment has been described above, the technical scope of the present disclosure is not limited to the range described in the exemplary embodiment. It is apparent from the description of the claims that an embodiment, in which various modifications or improvements are made to the exemplary embodiment, is also included in the technical scope of the present disclosure.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an attachment information assignor that assigns a comment made by a user to an electronic document as attachment information associated with a corresponding portion in the electronic document; and
a conclusion attribute assignor that assigns a conclusion attribute in association with the attachment information, the conclusion attribute being an attribute indicating a type of conclusion of the attachment information.

2. The information processing apparatus according to claim 1, further comprising
a display controller that performs control to display a plurality of pieces of attachment information, each of which is the attachment information based on a certain rule.

3. The information processing apparatus according to claim 2,
wherein the display controller performs control to collectively display the plurality of pieces of attachment information the conclusion attribute by the conclusion attribute

4. The information processing apparatus according to claim 2,
wherein the display controller performs control to collectively display the attachment information assigned the conclusion attribute and a comment which leads to the conclusion attribute.

5. The information processing apparatus according to claim 3,
wherein the display controller performs control to collectively display the attachment information assigned the conclusion attribute and a comment which leads to the conclusion attribute.

6. The information processing apparatus according to claim 3,
wherein the display controller performs control to display the attachment information in association with the attachment information assigned to the corresponding portion in the electronic document.

7. The information processing apparatus according to claim 3,
wherein for a plurality of electronic documents each of which is the electronic document, the display controller performs control to collectively display the plurality of pieces of attachment information based on the conclusion attribute.

8. The information processing apparatus according to claim 2,
wherein the display controller performs control to display the plurality of pieces of attachment information by changing at least one of a color and a stamp which indicate the conclusion attribute according to the conclusion attribute.

9. The information processing apparatus according to claim 3,
wherein the display controller performs control to display the plurality of pieces of attachment information by changing at least one of a color and a stamp which indicate the conclusion attribute according to the conclusion attribute.

10. The information processing apparatus according to claim 2,
wherein the display controller performs control to display the attachment information strongly associated with the conclusion attribute concurrently.

11. The information processing apparatus according to claim 3,
wherein the display controller performs control to display the attachment information strongly associated with the conclusion attribute concurrently.

12. The information processing apparatus according to claim 2,
wherein the display controller performs control to collectively display the plurality of pieces of attachment information so that representations of the plurality of pieces of attachment information do not overlap.

13. The information processing apparatus according to claim 3,
wherein the display controller performs control to collectively display the plurality of pieces of attachment information so that representations of the plurality of pieces of attachment information do not overlap.

14. The information processing apparatus according to claim 1, further comprising
a notifier that, when the conclusion attribute is assigned, notifies a user who has made a comment on the attachment information assigned the conclusion attribute.

15. The information processing apparatus according to claim 1, further comprising
a notifier that, when the conclusion attribute is not assigned in a predetermined period, notifies a user who is to assign the conclusion attribute.

16. An information processing system comprising:
an electronic document management apparatus that manages an electronic document viewed by a user; and
an information processing apparatus that assigns a comment made by the user to the electronic document,
wherein the electronic document management apparatus or the information processing apparatus includes:
an attachment information assignor that assigns a comment by a user to an electronic document as attachment information associated with a corresponding portion in the electronic document; and
a conclusion attribute assignor that assigns a conclusion attribute associated with the attachment information, the conclusion attribute being an attribute indicating a type of conclusion of the attachment information.

17. A non-transitory computer readable medium storing a program causing a computer to execute a process, the process comprising:
assigning a comment made by a user to an electronic document as attachment information associated with a corresponding portion in the electronic document; and
assigning a conclusion attribute in association with the attachment information, the conclusion attribute being an attribute indicating a type of conclusion of the attachment information.
